(19) United States
(12) Patent Application Publication
(10) Pub. No.: US 2012/0297011 A1
(43) Pub. Date: Nov. 22, 2012

(54) Intelligent Reception of Broadcasted Information Items

(75) Inventors: Kuifei Yu, Beijing (CN); Jian Ma, Beijing (CN); Chunliang Bi, Beijing (CN); Li Han, Beijing (CN)

(73) Assignee: NOKIA CORPORATION, Espoo (FI)

(21) Appl. No.: 13/519,406

(22) PCT Filed: Dec. 30, 2009
(86) PCT No.: PCT/CN09/76241

§ 371 Date: Jun. 27, 2012

(51) Int. Cl. G06F 15/167

(52) U.S. Cl. 709/213

(57) ABSTRACT

A method comprising: receiving a plurality of broadcasted information items in a client device; determining fondness of the information items to the user of the client device according to predefined criteria; and selecting a subset of the information items to be stored in a memory of the client device at least partly based on the determined fondness of the information items.

### FIELD OF THE INVENTION

The present invention relates to broadcasted information items, especially Internet information items, and more particularly to intelligent reception of such information items.

### BACKGROUND OF THE INVENTION

Although the amount of Internet information is increasing exponentially, there are only a small number of popular Internet sites catching the eyes of most Internet users. It has been investigated that approximately 85% of all Internet traffic is directed to and from the top 500 web sites. This makes it possible to aggregate the most interesting Internet content and distribute it to the users.

However, even with the aggregation of the most requested Internet content, the point-to-point characteristic of the current Internet, which is not efficient for the transmission of very large amount of Internet information, poses a significant bottleneck for the delivery of Internet content.

In terms of transmission efficiency, broadcast is a more suitable method, and actually the idea of wireless broadcasting Internet information through satellite or digital broadcasting system has been proposed by some researchers. Especially, on developing and rural areas having no or few wireline network connections, the broadcasted Internet information could be a viable solution for making Internet information easily available for people in those areas.

However, the amount of Internet information is huge and broadcasting Internet information is a tremendous task. The problems are especially emphasized on the receiving side, wherein the receiving apparatus should somehow filter the Internet information, which is meaningful for the user, to be received and stored, and at the same time consider the constraints of the limited memory space of the receiver. A further problem arises when the memory space of the receiver becomes full, i.e. how to meaningfully update the information without deleting important information.

### SUMMARY OF THE INVENTION

Now there has been invented an improved method and technical equipment implementing the method, by which the above problems are significantly alleviated. Various aspects of the invention include a method, an apparatus and a computer program, which are characterized by what is stated in the independent claims. Various embodiments of the invention are disclosed in the dependent claims.

According to a first aspect, there is provided a method comprising: receiving a plurality of broadcasted information items in a client device; determining fondness of the information items to the user of the client device according to predefined criteria; and selecting a subset of the information items to be stored in a memory of the client device at least partly based on the determined fondness of the information items.

According to an embodiment, the method further comprises: storing the information items having high determined fondness in a first memory part of the client device intended for long time storage of; and storing the information items having lower determined fondness in a second memory part of the client device intended for a temporary storage.

According to an embodiment, the method further comprises: organising the information items into a plurality of categories according to the type of information content of the information items.

According to an embodiment, the method further comprises: determining the fondness of the information items according to the equation F=α×W_{category}+(1−α)×W_{info}), wherein W_{category} is the weight of a possible category in which the information belongs to, W_{info} is the weight of the information item, and α represents the difference influence of said two weight factors for the fondness degree of the users.

According to an embodiment, the method further comprises: adjusting said weight factors according to browsing behaviour of the user of the client device, wherein at least one of the following user actions has impact on at least either of said weight factors:
the number of occasions of browsing the content and/or abstract of the information item;
time spent on browsing the content and/or abstract of the information item;
searching the information items by keywords;
marking a particular information item as “interested” or “not interested”; and
   re-determining the fondness of the information items according to said equation based on the adjusted weight factors.

According to an embodiment, the method further comprises: determining a replacement index for the information items stored in the second memory part; and in response to storing or updating a new information item in the second memory part, when the second memory part is essentially full, removing one or more of the information items having the highest value of the replacement index such that enough memory space will be made available for storing the new information item.

According to an embodiment, the method further comprises: determining the replacement index of the information items according to the equation d_{info}_{_{—}}ᵢ=c/(β×T_{info}_{_{—}}ᵢ+(1−β)×F_{info}_{_{—}}ᵢ), wherein T_{info}_{_{—}}ᵢ is the timeliness of the information item i, F_{info}_{_{—}}ᵢ is the fondness of the information item i, c is a constant and β represents the difference influence of the factors T_{info}_{_{—}}ᵢ and F_{info}_{_{—}}ᵢ regarding the replacement index of information item i.

According to an embodiment, the method further comprises: in response to the first memory part becoming essentially full, transferring information items having the lowest determined fondness to the second memory part.

According to an embodiment, a recommendation value is attached to the broadcasted information items, the method further comprising: adjusting the client device to receive broadcasted information item belonging to a particular information category and having a predetermined recommendation value.

The arrangement according to the various embodiments provides significant advantages. The arrangement enables the user of the client device to individually and automatically organize and update information when receiving information from Internet in the broadcast mode. It also facilitates the users to browse the information which he/she is interested in and saves users' reading time. The arrangement enables the user to preserve the significant information and delete the less significant information through an automated process that combines user's interest and user's browsing and operating history, and at the same time, takes into account the storage capacity of the client device.

According to a second aspect, there is provided an apparatus comprising:

means for receiving a plurality of broadcasted information items; means for measuring fondness of the information items to the user of the apparatus according to predefined criteria; and means for selecting a subset of the information items to be stored in a memory of the apparatus at least partly based on the measured fondness of the information items.

According to a third aspect, there is provided an apparatus comprising: at least one processor and at least one memory storing computer program code, wherein the at least one memory and stored computer program code are configured to, with the at least one processor, cause the apparatus to at least: receive a plurality of broadcasted information items; measure fondness of the information items to the user of the apparatus according to predefined criteria; and select a subset of the information items to be stored in a memory of the apparatus at least partly based on the measured fondness of the information items.

According to a fourth aspect, there is provided a computer program product, stored on a computer readable medium and executable in a data processing device, for carrying out the various embodiments.

According to a fifth aspect, there is provided a computer readable medium comprising computer program code, which computer program code, when executed in at least one processor, is configured to carry out the various embodiments.

These and other aspects of the invention and the embodiments related thereto will become apparent in view of the detailed disclosure of the embodiments further below.

### LIST OF DRAWINGS

In the following, various embodiments of the invention will be described in more detail with reference to the appended drawings, in which

FIG. 1 shows a display view according to an embodiment of the invention, wherein the information content is organized into categories;

FIG. 2 shows a flow chart of a replacement procedure for the renewable memory according to an embodiment of the invention;

FIG. 3 shows a flow chart of a replacement procedure for the reserved memory according to an embodiment of the invention; and

FIG. 4 shows a client device according to an embodiment of the invention in a reduced block chart.

### DESCRIPTION OF EXAMPLE EMBODIMENTS

In the following, example embodiments will be illustrated by referring to broadcasted Internet information. It is, however, noted that the embodiments are not limited to Internet information solely, but they can be implemented by utilizing any kind of digital information regardless of the original source of information. Moreover, the embodiments may be utilized in any kind of broadcast networks, for example in terrestrial television/radio networks, cable networks and satellite networks. It is also possible use the broadcast transmission options of wireless data networks, such as cellular networks.

According to an embodiment, the Internet information to be broadcasted is organized into categories and one or more of these categories has been assigned a certain amount of storage space in the receiving apparatus. According to an embodiment, a DTD (Document Type Definition) description may be attached to each webpage for better organizing and updating information. The description may include e.g. the size of the information item, publication time, title, abstract, type of the content of the information item, etc. Then, upon receiving the broadcasting Internet information, the receiving clients may easily obtain a “summary” of each webpage by parsing only the DTD information of each page.

The DTD definition of a webpage may be, for example, as follows:

<!-- Root element -->
<!ELEMENT Webpage (Title,Abstract,Content,Image*)>
<!ELEMENT Title (#PCDATA)>
<!ELEMENT Abstract (#PCDATA)>
<!ELEMENT Content (#PCDATA)>
<!ELEMENT Image (#PCDATA)>
<!ATTLIST Webpage Identifier ID #REQUIRED >
<!ATTLIST Webpage Size CDATA #REQUIRED >
<!ATTLIST Webpage Pubtime CDATA #REQUIRED >
<!ATTLIST Webpage Image_num CDATA #REQUIRED >
<!ATTLIST Webpage Category_Identifier IDREF #REQUIRED >
<!ATTLIST Image Size CDATA #REQUIRED >
<!--End of DTD -->

### Storing and Organizing the Internet Information

The receiving apparatus comprises at least a receiver for receiving the broadcasted Internet information, a memory for storing the Internet information at least temporarily and a processing unit.

According to an embodiment, the memory space is divided into two parts: Reserved memory and Renewable memory. These parts are controlled according to the interest of the user. The webpages, which the user presumably wants to preserve, are stored in the Reserved memory, and these webpages shall not be replaced, unless the user purposefully deletes them e.g. manually or through some automated process. The size of the Reserved memory could be set to a fixed value according to the actual needs. The information to be stored in the Renewable memory then depends on the interest of the user towards the specific information and the size of the available Renewable memory. The determination of these parameters will be described more in detail below.

According to an embodiment, the user can subscribe the Internet information by selecting information according to his/her interest from the broadcasted Internet information. There are at least two ways of making a subscription at the end of the client, i.e. a program table and a so-called recommendation degree.

The program table may be implemented in a similar manner as the electronic program guide (EPG) in the digital television systems. The DTD definitions of each webpage may be utilized in creating the program table. Thereby, a user may obtain the categories of information broadcasted and the start time and end time of each kind of information simply by investigating the program table. The user may then select the categories of information, which he is interested in, to be received by his/her receiving apparatus.

Furthermore, the user may also subscribe recommended information items according to their recommendation degree. This means that information items in certain categories are assigned a recommendation degree; for example a value between 1 and 5 according to their prevalence. The recommendation degree of an advertisement may be set by default as 1. The recommendation degree may be assigned by the producer of the information or the network service provider, for example. The recommendation degree may be, for example, automatically assigned by the server providing the internet information, wherein the basis for assigning the recommendation degree may be derived from how much the information item in question attracts the public interest. Thus for example, the click rate of the information item on the webpage or the position of the information item in the layout of website may affect to the recommendation degree. In addition to that, the producer of the information or the network service provider may assign a subjective recommendation degree for the information item.

Then, for example, a fan of English football may subscribe information items having a recommendation degree value of 2 or more in the category “English football”, whereas he/she may subscribe information items having a recommendation degree value of only 5 in the category “Spanish football”.

The receiving apparatus optionally further comprises a display, or at least a display may be functionally connected to the receiving apparatus for displaying the downloaded information content, which is stored either in the Reserved memory or in the Renewable memory. For the convenience of the user to read, all the information in both parts may be organized into categories.

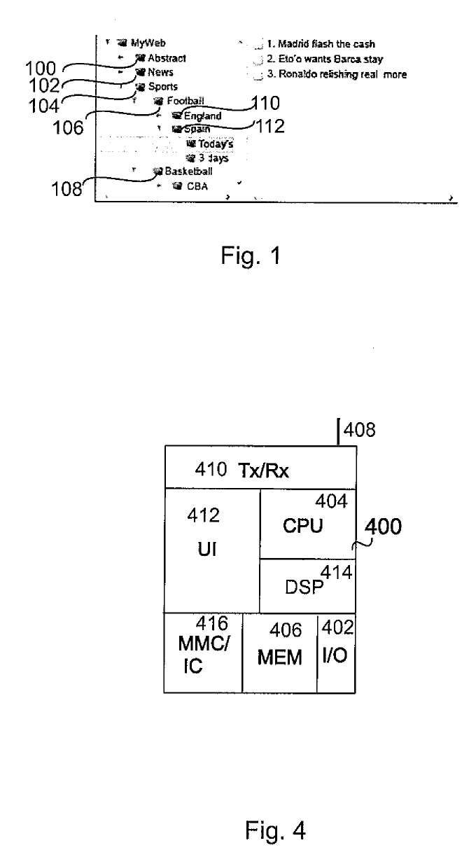

FIG. 1 shows an example of a display view, wherein the information content is organized into categories 100, 102, 104. Each category (such as “Sports”, 104) may contain a plurality of sub-categories (“Football” 106; “Basketball” 108, etc.) and each sub-category may also contain a plurality of sub-categories (such as “England” 110, “Spain” 112 in the sub-category “Football” 106). The chain of sub-categories within sub-categories is not limited by the organisational rules, but only the size of the memory may set limits for the number of sub-categories. In the display view of FIG. 1, the categories are displayed on the left-hand column, and the titles and/or abstracts of the information items on the right-hand column.

The title and/or abstract of the information items, which belong to the same category, are organized into one file upon receiving the information item and then they are sorted by publication time. The content of each webpage may be organized into one separate file with the title and the publication time. Thus, according to an embodiment, the received information is organized into categories firstly, and within a specific category, the information is organized into several folders (sub-categories) according to the publication time of the information. Thus, each category may have a plurality of timeline sub-categories, such as “today”, “yesterday”, “3 days ago”, etc.

According to an embodiment, the abstract/title and the actual content of the received Internet information may be displayed separately in the terminal. The abstract/title may, for example, provide a link to the actual content, and by selecting or click the abstract/title, the content of the webpage will be displayed in a separate window.

Furthermore, the information items within the folders are optionally sorted according to the fondness degree of the user, herein referred by a parameter F, which represents the degree of interest of the user towards a specific type of information. An embodiment for determining the parameter F will be described below more in detail. The parameter F could also be displayed along with the abstract/title.

It should, however, be noted that for the purpose of implementing the embodiments described herein below, it is not mandatory to organize the information into categories; it is merely for the convenience of the user to browse and read the information. Thus, the display view may also show all the information items from all the categories ranked by F.

### The Interest of Users

An advantageous aspect of the arrangement is to measure the interest of the user towards each category/sub-category and each information item, such as a webpage. As mentioned above, this is measured by the parameter F representing the fondness degree of the user for a particular category and/or an information item, such as a webpage. The total fondness degree F of the user is defined according to the equation

F=α×W_{category}+(1−α)×W_{info} (1.)

wherein W_{category} is the weight of the category in which the information item belongs to, W_{info} is the weight of the information item, and it initially equals to 0, and α represents the difference influence of said two weight factors for the fondness degree of the users. Advantageously, α may be a user-specific constant, which thus applies to all categories of the user similarly. However, α may be adjusted according to the preferences of the user.

In order to apply the total fondness degree F of the user for subscribing the Internet information the user is interested in and for creating a purposeful display view, some initial presumptions should be made regarding the weight factors. At the beginning, if the user subscribes a particular category i, the weight of this category W_{category}_{_{—}}ᵢ=0.5, otherwise W_{category}_{_{—}}i=0. As described above, the user may subscribe recommended information items according to their recommendation degree When an information item i is received, if it is recommended by the server, then W_{info}_{_{—}}ᵢ=W_{recommended}, otherwise W_{info}_{_{—}}ᵢ=0.

According to an embodiment, a predetermined threshold value λ could be set such that if the value F of an information item exceeds the threshold λ, the information item will be moved into the Reserved memory automatically.

The value of F is constantly changing and it is adjusted according to browsing behaviour of the user. For example, if the abstract of some category is browsed, it implies that the user is interested in the content of the category. In a similar manner, if the user searches for information by inputting keywords, it also implies that the user is very interested in the information. The user may be also interested in other information similar or related to the searched information. Moreover, every user has his/her natural speed of browsing a webpage and the speed can be deduced from the user's average browsing behaviour. Hence, if the time spent on browsing a particular webpage is longer than the average duration, it may also mean that the user is more interested in this webpage. And vice versa, a very short time spent on browsing a particular webpage may imply that the user is not interested in this webpage.

Consequently, based on these behavioural presumptions, the weight of each category and the weight of each information item may be adjusted according to the following regulations:

1. Every time the content of a webpage i is browsed, the weight of the webpage W_{info}_{_{—}}ᵢ is increased by Δw.

2. Every time the abstract of a particular category i is browsed, the weight of the category W_{category}_{_{—}}ᵢ is increased by Δw.

3. If the user is interested in a particular webpage, he/she can mark it as “interested”. The value of F_{info}_{_{—}}ᵢ is assigned as λ, thus causing the information item to be moved to the Reserved memory, and the weight of the category which it belongs to is increased by Δw.

4. If a webpage is marked as “no interest”, the value of F_{info}_{_{—}}ᵢ is assigned as 0, and the weight of the category which it belongs to is decreased by Δw.

5. If the user searches information by inputting keywords, the weight of the information items matching the query is increased by 2*Δw. The weight of the categories which the matching search results belong to is increased by Δw.

6. If the duration spent on browsing a webpage is less than 8, the weight of the webpage W_{info}_{_{—}}ᵢ is decreased by Δw.

After the adjustment of the above parameters, the value of F could be computed correspondingly. However, if the user is, for example, intensely studying a particular subject and browses a number of webpages relating to the subject, the fondness degree F. of those webpages and the category they belong to may raise disproportionally high. At the same time, some webpages and/or categories the user is basically interested in, but has not had time to browse, may fall to relatively low value of the fondness degree F.

Therefore, to avoid the overflow of F, two thresholds H (high) and L (low) representing the maximum and minimum of F are defined. The value of the fondness degree F. would then be re-evaluated according to the algorithm as follows:

If (F_{info}_{_{—}}ᵢ >= H) Then

For each F_{info}_{_{—}}ᵢ where F_{info}_{_{—}}ᵢ > λ:

F_{info}_{_{—}}ᵢ = F_{info}_{_{—}}ᵢ − sqrt(F_{info}_{_{—}}ᵢ − λ );

Elseif (F_{info}_{_{—}}ᵢ <= L ) Then

For each F_{info}_{_{—}}ᵢ where F_{info}_{_{—}}ᵢ < λ:

F_{info}_{_{—}}ᵢ = λ − sqrt(λ − F_{info}_{_{—}}ᵢ );

End If

The above algorithm thus guides the values of F, when exceeding the upper threshold H, to a level below the upper threshold H by subtracting a square root of (F_{info}_{_{—}}ᵢ−λ) from the value F_{info}_{_{—}}ᵢ exceeding the upper threshold H. On the other hand, if the values of F drop below the lower threshold L, then a new value is adjusted to F on the basis of λ, wherefrom a square root of (λ−F_{info}_{_{—}}ᵢ) is subtracted. The above algorithm thus guarantees that the values of F always remain within the boundaries of the upper and lower thresholds H and L.

Webpage Update with Limited Memory Space Available

Another advantageous aspect of the arrangement is the memory management; i.e. the vast amount of Internet information cannot continuously be stored in the limited memory space of the receiving apparatus. As described above, the memory space emay be divided into the Reserved memory and the Renewable memory, wherein the Renewable memory offers the primary source for memory updates, whereas the Reserved memory is meant for long-time storage of favoured information items.

Each webpage i has the attributes of (T_{info}_{_{—}}ᵢ, F_{info}_{_{—}}ᵢ, Size_{info}_{_{—}}ᵢ). T_{info}_{_{—}}ᵢ represents the timeliness of the information item i. F_{info}_{_{—}}ᵢ represents the fondness degree of user for the information item i, advantageously computed according to the equation (1). Size_{info}_{_{—}}ᵢ represents the size of storage space which is occupied by the information item i.

The value of T_{info}_{_{—}}ᵢ may be set according to the publication time of the received webpage, wherein the publication time may be obtained from the DTD definition of the webpage. The value of T_{info}_{_{—}}ᵢ is assigned such that the newer the webpage i is, the bigger is the value of T_{info}_{_{—}}ᵢ. For example, the webpage j, which was published 3 days ago, set T_{info}_{_{—}}ᵢ=n (0<n<1). The webpage k, which was published yesterday, set T_{info}_{_{—}}ₖ=s (0<s<1). Herein, n<s. The value of T_{info}_{_{—}}ᵢ could be adjusted according to the actual needs. Table 1 gives an example model for the timeliness of information.

TABLE 1
an example model for the timeliness of information (0 < l <
m < n < r < s < t < 1)

| | 7 days | 5 days | 3 days | 2 days | | |
|---|---|---|---|---|---|---|
| Pubtime | ago | ago | ago | ago | yesterday | today |
| T_{info}_{_{—}}ᵢ | l | m | n | r | s | t |

Next, a Replacement Index d is defined for information items stored in the Renewable memory for measuring the suitability of a webpage i to be replaced such that the bigger the value of d is, the more suitable the webpage i is for being replaced. The Replacement Index d of an information item i is defined according to the equation

d_{info}_{_{—}}ᵢ=c/(β×T_{info}_{_{—}}ᵢ+(1−β)×F_{info}_{_{—}}ᵢ) (2)

wherein c is a suitably selected constant and β represents the difference influence of the factors T_{info}_{_{—}}ᵢ and F_{info}_{_{—}}ᵢ regarding the Replacement Index of information item i. From the equation (2) it can be easily concluded that if the value of T_{info}_{_{—}}ᵢ is high, i.e. the information item is rather new, then the value of d_{info}_{_{—}}ᵢ becomes smaller, and vice versa. Similarly, if the value of F_{info}_{_{—}}ᵢ is high, i.e. the user is more interested in this information item, the d_{info}_{_{—}}ᵢ is smaller, and vice versa. If it is chosen that β<0.5, then F_{info}_{_{—}}ᵢ influences the value of Replacement Index more than the timeliness factor T_{info}_{_{—}}ᵢ. In other words, in such a case the user puts more weight on the fondness of information than on the timeliness of the information. Both the value of c and β could be determined according to the actual needs. Nevertheless, equation (2) controls the management of the Renewable memory such that older and less interesting information items are more eligible to be replaced by newer and more interesting information items.

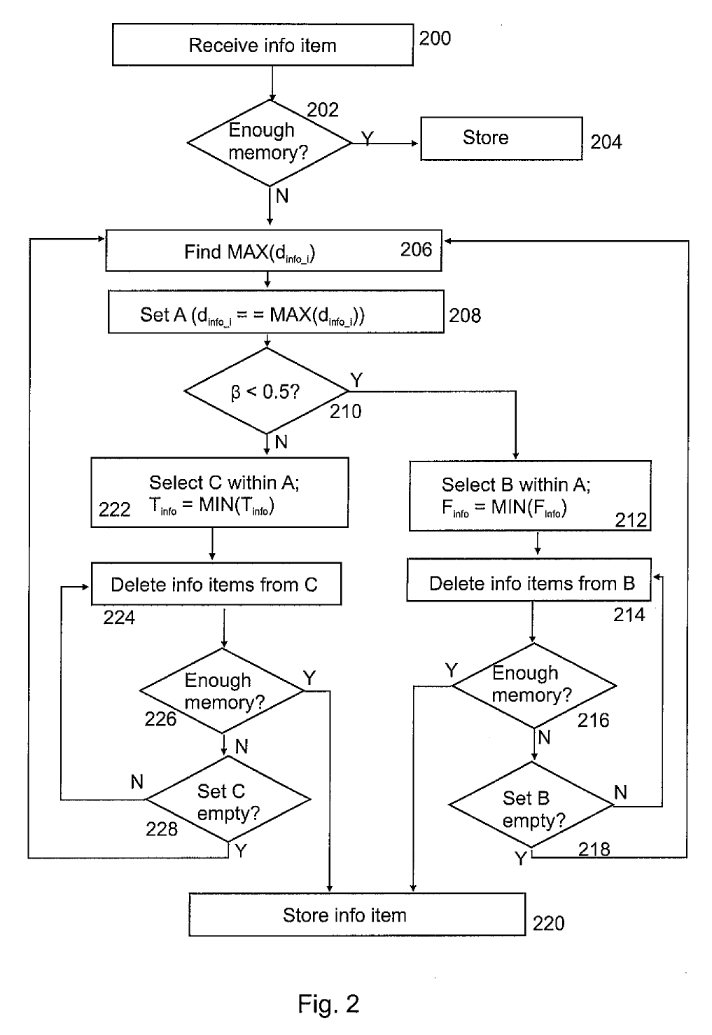

FIG. 2 shows a flow chart illustrating a replacement procedure for the Renewable memory according to an embodiment. In this embodiment, it is assumed that each category has been assigned a certain amount of storage space (e.g. a memory section) in the Renewable memory. In the beginning, the receiving apparatus receives (200) an information item, for example a new webpage, belonging to a certain category. The receiving apparatus first checks (202), whether there is enough memory space in this category available for storing the webpage. If affirmative, then the webpage is stored (204) as such in the memory section assigned to this category.

However, if there is not enough memory for storing the new webpage in the assigned memory section, then it is first determined (206) the maximum value of the Replacement Index (Find MAX(d_{info}_{_{—}}ᵢ)) of the information items in this category. Next, an information item set A is determined (208) where d_{info}_{_{—}}ᵢ==MAX(d_{info}_{_{—}}ᵢ), i.e. the set A includes the information items of the memory section, which are most eligible to be replaced. Then it is checked (210) if (β<0.5), i.e. whether the user puts more weight on the fondness of information than on the timeliness of the information.

If true, then it is determined the minimum value of the fondness degree (Find MIN(F_{info}_{_{—}}ᵢ)) within the information items in set A, and an information item set B is determined (212) from the set A where F_{info}_{_{—}}ᵢ==MIN(F_{info}_{_{—}}ᵢ), i.e. the set B includes the information items from the set A, which are the least interesting to the user. Thereafter, information items from set B are deleted (214) in random order, and after every deletion it is checked (216) if the free size of the memory section is enough for the new webpage. If yes, then the webpage is stored (220) in the memory section assigned for the particular category; if no, it is checked (218) if there are still information items in the set B to be deleted. If the set B is not empty, then the deletion is continued from the step 214; if the set B is empty, then the process is continued from the step 206, wherein a new maximum value of the Replacement Index (Find MAX(d_{info}_{_{—}}ᵢ)) of the remaining information items in this category is determined.

However, if it is noticed in step 210 that β=>0.5, i.e. the user puts more weight on the timeliness of the information than on the fondness of information, then it is determined the minimum value of the timeliness (Find MIN(T_{info}_{_{—}}ᵢ)) within the information items in set A, and an information item set C is determined (222) from the set A where T_{info}_{_{—}}ᵢ==MIN(T_{info}_{_{—}}ᵢ), i.e. the set C includes the information items from the set A, which have the oldest publication date. Thereafter, information items from set C are deleted (224) in random order, and after every deletion it is checked (226) if the free size of the memory section is enough for the new webpage. If yes, then the webpage is stored (220) in the memory section assigned for the particular category; if no, it is checked (228) if there are still information items in the set C to be deleted. If the set C is not empty, then the deletion is continued from the step 224; if the set C is empty, then the process is continued from the step 206, wherein a new maximum value of the Replacement Index (Find MAX(d_{info}_{_{—}}ᵢ)) of the remaining information items in this category is determined.

The steps of the above process may also be depicted with pseudo-code language as follows:

Begin

Size_{free} = Free size of Renewable memory;
Do While (Size_{free} < Size_{need})

```
  Find MAX(d_{info}_{_{—}}ᵢ) of information items in this category;
  Find the information item set A where d_{info}_{_{—}}ᵢ==
  MAX(dinfo_i);
  If (S(A) != 1) Then
```

If (β < 0.5) Then

Find MIN(F_{info}_{_{—}}ᵢ) of information items in set A;

Select the information item set B from the set A where
F_{info}_{_{—}}ᵢ == MIN(F_{info}_{_{—}}ᵢ);
Do While (B is not NULL)

```
  Delete information item i from set B randomly;
  Size_{free} += Size_{info}_{_{—}}ᵢ
  If (Size_{free} >= Size_{need})
```

Break;

End If

Loop
Else

```
  Find MIN(T_{info}_{_{—}}ᵢ) of information items in set A;
  Select the information item set C from the set A
  where T_{info}_{_{—}}ᵢ == MIN(T_{info}_{_{—}}ᵢ);
  Do While (C is not NULL)
```

Delete information item i from set C randomly;
Size_{free} += Size_{info}_{_{—}}ᵢ;
If (Size_{free} >= Size_{need})

Break;

End If

```
  Loop
  End If
  Else
```

Delete information item i in set A;
Size_{free} += Size_{info}_{_{—}}ᵢ;

End If

Loop

End

According to an embodiment and as mentioned above, the above process may also be applied even if the information is not organized into categories, only some minor modifications are needed. Firstly, the computation of the fondness degree F. is simplified, since we may set α=0 in the equation (1), resulting in

F=W_{info} (3)

Once the value of the fondness degree F. has been computed according to the equation (3), the value of the Replacement Index could also be computed for each individual information item according to the equation (2). Then the replacement procedure can be carried out according to the same procedure as in FIG. 2, however, with the minor modification in step 206 that instead of determining the maximum value of the Replacement Index of the information items in the particular category, the maximum value of the Replacement index is determined in all information items stored in the Renewable memory.

As mentioned above, the favourite information items of the user, which are stored in the Reserved memory, shall not be replaced, unless the user purposefully deletes them e.g. manually. However, the user may select a lot of information items as his/her favourite item, so that the size of the favourite items eventually reaches the size of the Reserved memory. Therefore, according to an embodiment, when the size of the Reserved memory is exceeded by the favourite information items of the user, one or more information items in the Reserved memory will be transferred to the Renewable memory.

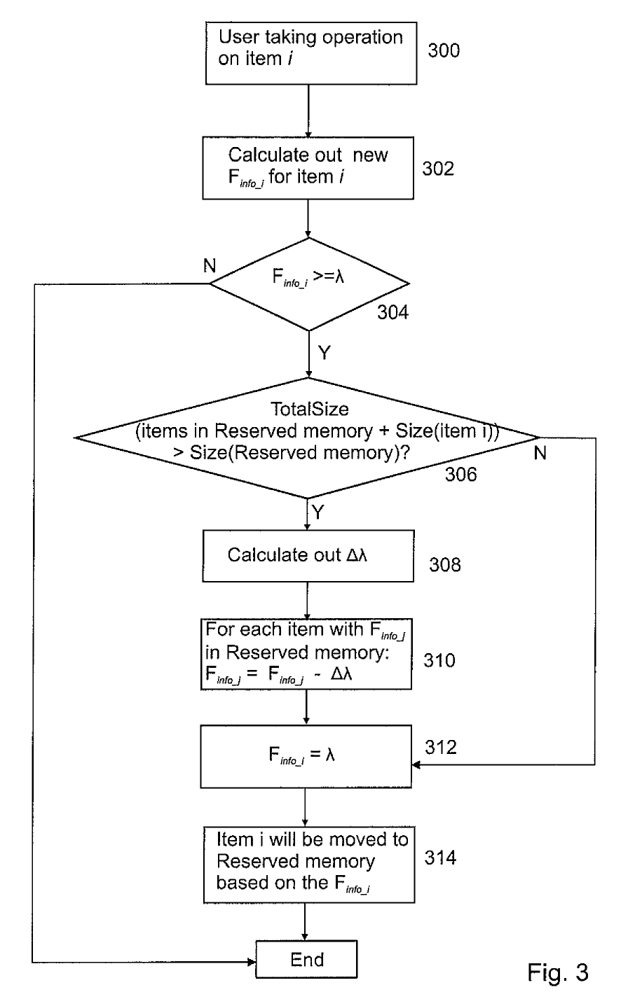

FIG. 3 shows a flow chart illustrating a replacement procedure for the Reserved memory according to an embodiment, wherein in a case of the Reserved memory becoming completely reserved, information items having lower fondness degree F. will be transferred to the Renewable memory.

In the beginning, the user takes (300) an operation on an information item i, for example browses a webpage i, whereupon a new value of the fondness degree F_{info}_{_{—}}ᵢ will be determined (302) for the information item i. The fondness degree F_{info}_{_{—}}ᵢ will be determined according to equation (1), and the values of W_{category} and W_{info} may be adjusted according to the rules described above. Next, it is examined (304) whether the value of the fondness degree F_{info}_{_{—}}ᵢ exceeds, or at least equals to, the value of λ, i.e. the threshold value indicating that the information item belongs to the group of “interested” defined by the user. If the value of the fondness degree F_{info}_{_{—}}ᵢ does not exceed or equal to the value of λ, no storage operation is carried out for the information item in the Reserved memory, but possibly in the Renewable memory.

However, if the value of the fondness degree F_{info}_{_{—}}ᵢ exceeds or equals to the value of λ, it is examined (306) whether available memory space in the Reserved memory allows to store the information item i. If there is not enough memory space in the Reserved memory, then the value of the fondness degree F_{info}_{_{—}}ᵢ is assigned (312) the value of λ, and the information item i is stored (314) in the Reserved memory.

However, in a case of insufficient memory space (306) in the Reserved memory, it should be decided which information items should be removed from the Reserved memory. For that purpose, the values of the fondness degree F_{info}_{_{—}}ᵢ of each information item in the Reserved memory will be decreased by a sufficient value such that it allows to free enough memory space for the storage of the information item i. Thus, a new parameter Δλ will be determined (308), giving the sufficient decrease for adjusting the memory content. An embodiment for determining the parameter Δλ will be described below more in detail.

Once the value of the parameter Δλ has been determined, the values of the fondness degree F_{info}_{_{—}}ᵢ of each information item j stored in the Reserved memory will be decreased (310) by the value of Δλ: F_{info}_{_{—}}ᵢ=F_{info}_{_{—}}ᵢ−Δλ. The value of Δλ may be so adjusted that at least for a part of information items j stored in the Reserved memory, the updated value of the fondness degree F_{info}_{_{—}}ᵢ will drop below the value of λ. These information items will be removed from the Reserved memory, possibly transferred into the Renewable memory, thus making some memory space in the Reserved memory available for storing new information items. Thereafter, the information item i will be assigned (312) the value of λ, and the information item i is stored (314) in the Reserved memory.

According to an embodiment, for determining the parameter Δλ (step 308 in FIG. 3) it is first determined a sufficient amount of memory space in the Reserved memory that should be made available, for example 10% of the total size of the Reserved memory. Then, an information item set A is determined from all information items in Reserved memory where F_{info}_{_{—}}ᵢ==MIN(F_{info}_{_{—}}ᵢ), i.e. the set A includes the information items of the Reserved memory, which are the least interesting to the user. Then it is examined whether the sufficient amount of memory space (e.g. 10%) in the Reserved memory could be freed by removing one or more information items from the set A; if not, a new set A with a higher value of F should be determined. Once the value of F resulting in making a sufficient amount of memory space available has been found, the value of the parameter Δλ is defined as: Δλ=F−λ; i.e. a change required to drop a sufficient amount of information items to the value of the fondness degree F_{info}_{_{—}}ᵢ below to the value of the parameter λ.

The steps of the above process may also be depicted with pseudo-code language as follows:

Begin

Sizefree = Free size of Reserved memory;
T = the set of all information items in Reserved memory;
Do While (Sizefree < 0.1*Size(Reserved memory))

f = MIN( Fondness degree of all items in T);
Find the information item set A where F_{info}_{_{—}}ⱼ == f;
If (S(A) != 1) Then

Do While (A is not NULL)

Choose an item i from set A randomly;
T = T − {i};
A = A − {i};
Size_{free} += Size_{info}_{_{—}}ᵢ;
If (Size_{free} > 0.1*Size(Reserved memory))

Break;

End If

Loop

Else

```
  T = T − A;
  Size_{free} += Sizeᵢₜₑₘ_{_{—}}ᵢₙ_{_{—}}_{A} ;
```

End If

Loop
Δλ = f − λ;

End

A skilled man appreciates that any of the embodiments described above may be implemented as a combination with one or more of the other embodiments, unless there is explicitly or implicitly stated that certain embodiments are only alternatives to each other.

FIG. 4 illustrates a simplified structure of an apparatus 400 capable of operating as a client device in the above arrangement. The apparatus 400 can be, for example, a mobile terminal, a MP3 player, a PDA device, a personal computer (PC), a television receiver/set-top box or any other data processing device. The apparatus comprises I/O means 402 (I/O), a central processing unit 404 (CPU) and memory 406 (MEM). The memory 406 comprises a read-only memory ROM portion and a rewriteable portion, such as a random access memory RAM and FLASH memory. The rewritable portion of the memory comprises the Reserved memory and the Renewable memory described above. The information, which is used to communicate with different external parties, e.g. a CD-ROM, other devices and the user, is transmitted through the I/O means 402 to/from the central processing unit 404. The apparatus comprises means for receiving broadcast transmission, e.g. an antenna 408 and a receiver 410. If the apparatus is implemented as a mobile station, it typically includes a transceiver 410 (Tx/Rx), which communicates with the wireless network, typically with a base transceiver station (BTS) through the antenna 408. User Interface 412 (UI) equipment typically includes a display, a keypad, a microphone and connecting means for headphones. The apparatus may further comprise a dedicated digital signal processor 414 (DSP) and connecting means 416 (MMC), such as a standard form slot for various hardware modules, or for integrated circuits IC, which may provide various applications to be run in the apparatus.

Accordingly, the process of intelligent reception of broadcasted information items may be implemented in the apparatus for example such that means for receiving, such as the receiver 410, is arranged to receive a plurality of broadcasted information items. Then the central processing unit (CPU) 404 or a dedicated digital signal processor (DSP) 414 of the apparatus determines the fondness of the received information items according to predefined criteria stored in the apparatus. The CPU or DSP then selects, on the basis of said determination, the information items that shall be stored in the memory 406 of the apparatus. Similarly, the processes of e.g. determining the fondness of the information items, determining the replacement index for the information items stored in the Renewable memory, deciding the information items to be removed from the Renewable/Reserved memory etc, are also carried out in the CPU or DSP. Thus, the CPU or the DSP may provide the means for measuring fondness of the information items to the user of the apparatus according to predefined criteria, and the means for selecting a subset of the information items to be stored in a memory of the apparatus at least partly based on the measured fondness of the information items.

Consequently, the functionalities of the embodiments may be implemented in the receiving apparatus as a computer program which, when executed in a central processing unit CPU or in a dedicated digital signal processor DSP, affects the apparatus to implement procedures of the invention. Functions of the computer program SW may be distributed to several separate program components communicating with one another. The computer software may be stored into any computer-readable memory means, such as the hard disk of a PC or a CD-ROM disc, from where it can be loaded into the memory of apparatus. The computer software can also be loaded through a network, for instance using a TCP/IP protocol stack.

It is also possible to use hardware solutions or a combination of hardware and software solutions to implement the inventive means. Accordingly, the above computer program product can be at least partly implemented as a hardware solution, for example as ASIC or FPGA circuits, in a hardware module comprising connecting means for connecting the module to an electronic device, or as one or more integrated circuits IC, the hardware module or the ICs further including various means for performing said program code tasks, said means being implemented as hardware and/or software.

It is obvious that the present invention is not limited solely to the above-presented embodiments, but it can be modified within the scope of the appended claims.

1-32. (canceled)

33. A method comprising:
receiving a plurality of broadcasted information items in a client device;
determining fondness of the information items to the user of the client device according to predefined criteria; and
selecting a subset of the information items to be stored in a memory of the client device at least partly based on the determined fondness of the information items.

34. The method according to claim 33, the method further comprising:
storing the information items having high determined fondness in a first memory part of the client device intended for a long time storage; and
storing the information items having lower determined fondness in a second memory part of the client device intended for a temporary storage.

35. The method according to claim 34, the method further comprising:
organising the information items into a plurality of categories according to the type of information content of the information items.

36. The method according to claim 33, the method further comprising:
determining the fondness of the information items according to the equation F=α×W_{category}+(1−α)×W_{info}
wherein W_{category} is the weight of a possible category in which the information item belongs to, W_{info} is the weight of the information item, and α represents the difference influence of said two weight factors for the fondness degree of the users.

37. The method according to claim 36, the method further comprising:
adjusting said weight factors according to browsing behaviour of the user of the client device, wherein at least one of the following user actions has impact on at least either of said weight factors:
the number of occasions of browsing the content and/or abstract of the information item;
time spent on browsing the content and/or abstract of the information item;
searching the information items by keywords;
marking a particular information item as “interested” or “not interested”; and
re-determining the fondness of the information items according to said equation based on the adjusted weight factors.

38. The method according to claim 34, the method further comprising:
determining a replacement index for the information items stored in the second memory part; and
in response to storing or updating a new information item in the second memory part, when the second memory part is essentially full,
removing one or more of the information items having the highest value of the replacement index such that enough memory space will be made available for storing the new information item.

39. The method according to claim 38, the method further comprising:
determining the replacement index of the information items according to the equation d_{info}_{_{—}}ᵢ=c/(β×T_{info}_{_{—}}ᵢ+(1−β)×F_{info}_{_{—}}ᵢ)
wherein T_{info}_{_{—}}ᵢ is the timeliness of the information item i, F_{info}_{_{—}}ᵢ is the fondness of the information item i, c is a constant and β represents the difference influence of the factors T_{info}_{_{—}}ᵢ and F_{info}_{_{—}}ᵢ regarding the replacement index of information item i.

40. The method according to claim 34, the method further comprising:
in response to the first memory part becoming essentially full,
transferring information items having the lowest determined fondness to the second memory part.

41. The method according to claim 33, wherein a recommendation value is attached to the broadcasted information items, the method further comprising:
adjusting the client device to receive broadcasted information item belonging to a particular information category and having a predetermined recommendation value.

42. An apparatus comprising at least one processor and at least one memory storing computer program code, wherein the at least one memory and stored computer program code are configured to, with the at least one processor, cause the apparatus to at least:
receive a plurality of broadcasted information items;
measure fondness of the information items to the user of the apparatus according to predefined criteria; and
select a subset of the information items to be stored in a memory of the apparatus at least partly based on the measured fondness of the information items.

43. The apparatus according to claim 42, wherein
the memory of the apparatus comprises at least a first part intended for long time storage of the information items having high measured fondness and a second part intended for a temporary storage of the information items having lower measured fondness.

44. The apparatus according to claim 42, wherein the at least one memory and stored computer program code are further configured to, with the at least one processor, cause the apparatus to at least:
organise the information items into a plurality of categories according to the type of information content of the information items.

45. The apparatus according to claim 42, wherein the at least one memory and stored computer program code are further configured to, with the at least one processor, cause the apparatus to at least:
determine the fondness of the information items according to the equation F=α×W_{category}+(1−α)×W_{info}
wherein W_{category} is the weight of a possible category in which the information item belongs to, W_{info} is the weight of the information item, and α represents the difference influence of said two weight factors for the fondness degree of the users.

46. A computer program product, stored on a computer readable medium and executable in a data processing device, for receiving broadcasted information items, the computer program product comprising:
a computer program code section for controlling the reception of a plurality of broadcasted information items in the data processing device;
a computer program code section for determining fondness of the information items to the user of the data processing device according to predefined criteria; and
a computer program code section for selecting a subset of the information items to be stored in a memory of the data processing device at least partly based on the determined fondness of the information items.

47. The computer program product according to claim 46, further comprising:
a computer program code section for organising the information items into a plurality of categories according to the type of information content of the information items.

48. The computer program product according to claim 46, further comprising:
a computer program code section for determining the fondness of the information items according to the equation F=α×W_{category}+(1−α)×W_{info}
wherein W_{category} is the weight of a possible category in which the information item belongs to, W_{info} is the weight of the information item, and α represents the difference influence of said two weight factors for the fondness degree of the users.

49. The computer program product according to claim 48, further comprising:
a computer program code section for adjusting said weight factors according to browsing behaviour of the user of the apparatus, wherein at least one of the following user actions has impact on at least either of said weight factors:
the number of occasions of browsing the content and/or abstract of the information item;
time spent on browsing the content and/or abstract of the information item;
searching the information items by keywords;
marking a particular information item as “interested” or “not interested”; and
a computer program code section for re-determining the fondness of the information items according to said equation based on the adjusted weight factors.

50. The computer program product according to claim 46, further comprising:
a computer program code section for determining a replacement index for the information items stored in the second memory part; and
a computer program code section, responsive to said processing unit selecting a new information item to be stored or updated in the second memory part, when the second memory part is essentially full, for controlling one or more of the information items having the highest value of the replacement index to be removed such that enough memory space will be made available for storing the new information item.

51. The computer program product according to claim 46, further comprising:
a computer program code section, responsive to the first memory part becoming essentially full, for controlling information items having the lowest determined fondness to be transferred to the second memory part.

52. The computer program product according to claim 46, further comprising:
a computer program code section for receiving a recommendation value attached to the broadcasted information items, and
a computer program code section for selecting broadcasted information items belonging to a particular information category and having a predetermined recommendation value to be stored in the memory.
